(19) United States
(12) Patent Application Publication
(10) Pub. No.: US 2014/0074359 A1
(43) Pub. Date: Mar. 13, 2014

(54) SYSTEM AND METHOD FOR ANIMAL CRASH AVOIDANCE

(71) Applicant: Laurie Kay Lane, Rochester, MI (US)

(72) Inventor: Laurie Kay Lane, Rochester, MI (US)

(73) Assignee: CONTINENTAL AUTOMOTIVE SYSTEMS, INC., Auburn Hills, MI (US)

(21) Appl. No.: 13/606,154

(22) Filed: Sep. 7, 2012

(51) Int. Cl. G06F 17/00; H04N 5/33; B60Q 1/00; H04N 7/18

(52) U.S. Cl. 701/45; 348/148; 340/435; 348/E07.085; 348/E05.09

(57) ABSTRACT

A safety system for a vehicle is utilized as an animal detection system. By using an infrared camera and other sensors and/or cameras the safety system may detect an object in an area around the vehicle. A controller analyzes data from the sensors and/or cameras and determines if the object is an animal. If the object is determined to be an animal the controller initiates a response to avoid or minimize the chance of impacting the animal. A warning signal(s) is provided to the vehicle operator. A deterrent signal(s) is used to deter the animal from approaching the vehicle. Also, the animal detection system may send a signal to at least one other safety system for the vehicle to provide a crash avoidance response and/or to provide a crash preparation response.

### TECHNICAL FIELD

The present disclosure relates to automotive vehicles and more particularly to safety systems for automotive vehicles.

### BACKGROUND

Millions of accidents occur each year globally resulting from vehicles impacting animals that may cross the road or path of the vehicle. Insurance claims resulting from these accidents can cost insurance companies millions of dollars. The typical animal and vehicular accidents that occur can vary according to the geographic area and time of year. Certain areas of the road system can be known problem areas, but it is difficult to predict exactly when and where animals will cross the path of the vehicles. Additionally, animals are likely to be moving around at times when visibility is lowered, such as dawn, dusk and during the night.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A safety system for a vehicle is utilized as an animal detection system. By using an infrared camera and other sensors and/or cameras the safety system may detect an object in an area around the vehicle. A controller analyzes data from the sensors and/or cameras and determines if the object is an animal. If the object is determined to be an animal the controller initiates a response to avoid or minimize the chance of impacting the animal. A warning signal(s) is provided to the vehicle operator, such as a visual or audio signal. A deterrent signal(s) is used to warn the animal away from the vehicle. Also, the animal detection system may send a signal to at least one other safety system for the vehicle to provide a crash avoidance response and/or to provide a crash preparation response.

A safety system for a vehicle comprises at least one sensor mounted such that an object outside the vehicle may be detected by the at least one sensor. An electronic control unit for the safety system, is connected to the at least one sensor to determine if an object outside of the vehicle is an animal. An indicator unit is connected to the electronic control unit. The indicator unit is capable of providing an indicator to an operator of the vehicle to warn the operator when the electronic control unit determines that an animal has been detected. An external signal device also provides at least one of an audio or visual signal to deter an animal from approaching the vehicle.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic illustration of a vehicle having a animal detection and safety system of the present invention; and

FIG. 2 is a schematic illustration of a method of detecting an animal with the animal detection and safety system of FIG. 1.

### DETAILED DESCRIPTION

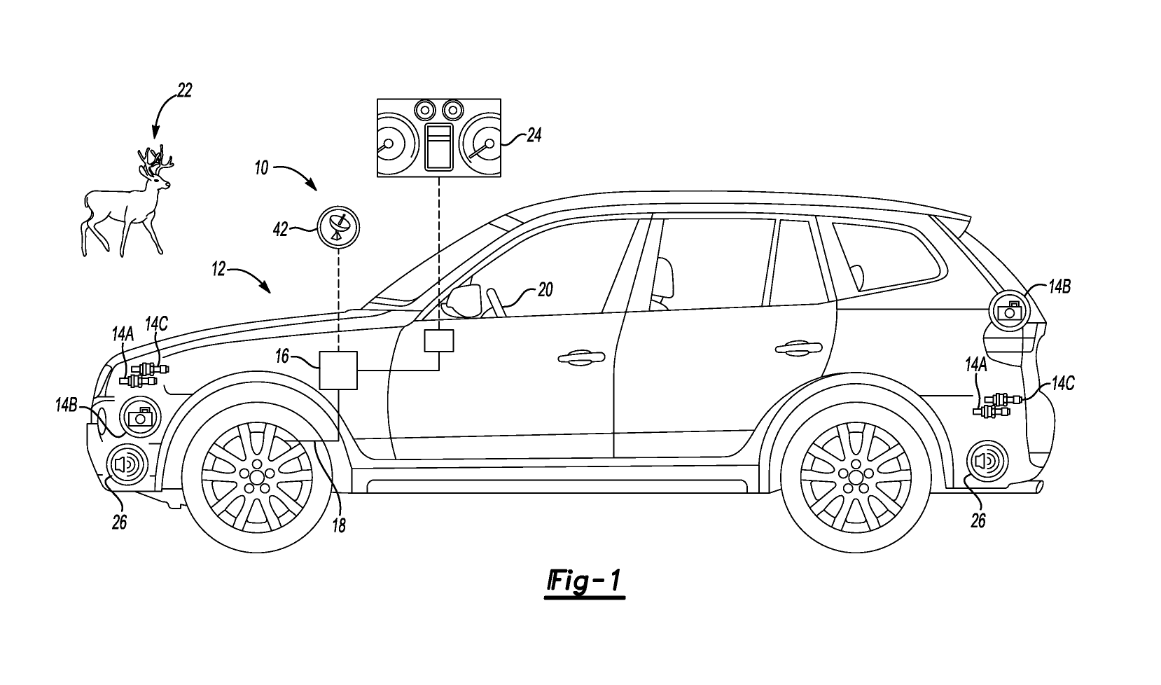

The following description is merely exemplary in nature and is in no way intended to limit the disclosure, its application, or uses. For purposes of clarity, the same reference numbers will be used in the drawings to identify similar elements. FIG. 1 illustrates a vehicle 10 having an animal detection and safety system 12. The vehicle 10 includes a plurality of sensors 14A-C. An electronic control unit (ECU) 16 for the animal detection and safety system 12 is connected to the sensors 14A-C, to a brake system 18 and possibly to additional vehicle systems 20 as well. The ECU 16 for the animal detection and safety system 12 may be the ECU 16 used by other vehicle systems 20, such as passive safety systems and driver assistance systems.

The plurality of sensors 14A-C may include heat sensing technology such as infrared cameras 14B. Other sensors 14A,C may be mono- or stereo-cameras radar or lidar sensors that may detect distance or speed of objects around the vehicle 10. The sensors 14A-C may be utilized by other vehicle system 20 for other purposes such as adaptive cruise control or park assist systems.

Upon detection of an animal 22 the animal detection and safety system 12 may send a warning signal(s) 24 that may be detected by an operator of the vehicle 10. Additionally, a deterrent signal(s) 26 may be emitted from the vehicle 10 to deter the detected animal from approaching the vehicle 10. The deterrent signal(s) 26 may an audio or visual signal or a combination thereof, such as strobing or colored high beams of the vehicle 10 headlights along with a whistle at a frequency for animal hearing. The deterrent signal(s) 26 may be a preselected audio or visual signal that would deter most types of animals. Alternatively, since different animals may be deterred by different audio or visual signals the deterrent signal(s) 26 may be adjusted by the driver. For example, the operator of the vehicle 10 may select the type of animal that the safety system 12 is set to deter based upon the location and time of year that they are driving the vehicle 10. That is, those who live in areas of high deer, moose or bear populations would select those animals. Once the type of animal is selected the safety system 12 will provide the deterrent signal(s) 26 which corresponds to that type of animal. The deterrent signal(s) 26 for that type of animal will be emitted anytime an animal is detected, until or unless the operator of the vehicle 10 changes the type of animal 22 selected.

Alternatively, the safety system 12 may select the type of deterrent signal(s) 26 based upon the GPS location of the vehicle 10 and the current date using previous detection and known animal traffic information. Another way the safety system 12 may determine the type of deterrent signal(s) 26 is by a general identification of the type of animal detected, e.g. large or small mammal, reptile, etc.

At least one other safety system 20 for the vehicle 10 is connected to the ECU 16, in FIG. 1 the brake system 18 is shown and the supplemental restraint system is illustrated as the other safety system 20. The ECU 16 may provide a signal to the brake system 18 and/or other safety system(s) 20 to provide an accident avoidance response and/or an accident preparation response for the vehicle 10. For example, by pre-charging the brakes, slowing the car, turning on the high beam headlights, etc. Therefore, the other safety system(s) 20 may be a warning device, an active driver assistance system, an airbag deployment unit, or a seat belt tensioner, or other similar systems.

Additionally, the ECU 16 is connected to at least one communication system 42 to send a signal to an external location regarding information about the animal detection. The safety system 12 may alert other vehicles 10 in the area and/or may send information to an external database. The information for the external database including time and location of the animal detection as well as the type and number of animals detected. The location information may include information such as a GPS location of the vehicle 10, relative location of the animal 22, direction of travel for the vehicle 10 and the animal 22, time and date. This information can be used by safety systems 12 in other vehicles and for future reference for detecting and warning of animal presence. Further, the animal detection and safety system 12 may also alert a vehicle operator when the vehicle 10 is in an area that is indicated for high animal presence or where the vehicle 10 or other vehicles have detected animal presence. For example, the animal detection and safety system 12 may provide a heads up display, such as “High Wildlife Area”, when entering an area of high animal population to alert the operator of the vehicle 10. The animal detection and safety system 12 may also slow the vehicle 10 speed when entering a high population area. The external database may be connected to sites such as insurance company databases, animal friendly organizations, or the Department of Natural Resources which may track accidents involving animals or movements of the animal population. Information of sightings that are more recent may be given weight by the ECU 16 to determine when the vehicle 10 is in a high population area, or this may be predetermined by the external database.

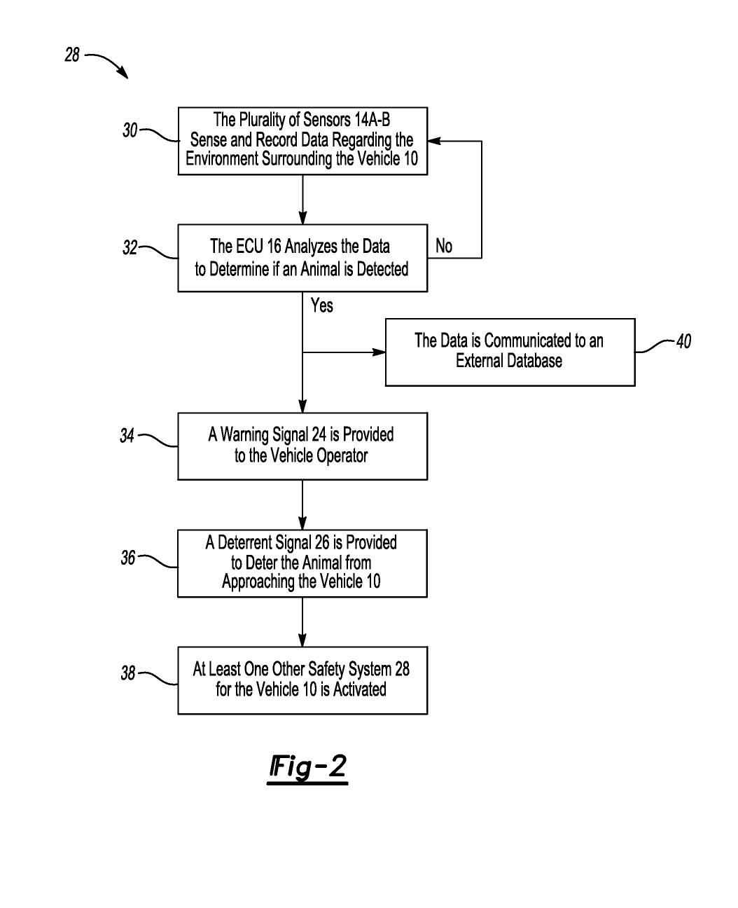

FIG. 2 is a schematic illustration of a method of detecting an animal 22 with the animal detection and safety system 12, illustrated at 28. The animal detection and safety system 12 may be programmed to detect any animal or a specific animal may be selected as the preferred detection animal, or the most likely animal detected. Using the plurality of sensors 14A-C the safety system 12 would sense and record data regarding the environment surrounding the vehicle 10, step 30. The ECU 16 for the safety system 12 would analyze the data to determine if an animal is detected, step 32. Analyzing the data may include gathering data from the vehicle GPS or other systems regarding information about previous animal sighting or population density, such as a database from insurance companies or the Department of Natural Resources.

The ECU 16 would also determine which type of animal 22 is being detected. If a specific animal 22 has been selected by the operator of the vehicle 10 the ECU 16 may give preference to that type of animal 22 when determining which type of animal is detected. The safety system 12 may provide a warning signal(s) 24 to be detected by the operator of the vehicle 10 to warn the operator of the presence of an animal 22, step 34. The warning signal(s) 24 may be visual, audio or a combination thereof to alert the driver that an animal is detected in the area surrounding the vehicle 10. For example, the location of the animal relative to the car could be displayed on an available display screen while a warning beep is simultaneously sounded. In addition, based upon the type of animal 22 detected the safety system 12 may issue a deterrent signal(s) 26 to deter the animal from approaching the vehicle 10, step 36. Again the deterrent signal(s) 26 may be visual, audio or a combination thereof. The deterrent signal(s) 26 and the driver warning(s) 24 may occur at the same time, or one in succession of the other.

The ECU 16 may also alter the response of at least one other safety system 28 for the vehicle 10 based upon the type of animal detected, step 38. For example, by pre-charging the brakes, slowing the car, turning on the high beam headlights, etc. The safety system 12 may alert other vehicles 10 in the area and/or may send information to an external database, step 40. The information for the external database including time and location of the animal detection as well as the type and number of animals detected. This information can be used by safety systems 12 in other vehicles and for future reference for detecting and warning of animal presence.

Therefore, the safety system 12 for the vehicle 10 is an animal detection system. By using the sensors 14A-C the safety system 12 may detect an object 22 in an area around the vehicle 10. A controller 16 analyzes data from the infrared camera 14B and/or other sensors and cameras 14A-C and determines if the object 22 is an animal. If the object 22 is determined to be an animal the controller 16 initiates a response to avoid or minimize the chance of impacting the animal 16. A warning signal(s) 24 is provided to the vehicle operator. A deterrent signal(s) 26 is used to warn the animal 16 away from the vehicle 10. Also the animal detection system 12 may send a signal to at least one other safety system 20 for the vehicle to provide a crash avoidance response and/or to provide a crash preparation response.

While the best modes for carrying out the invention have been described in detail the true scope of the disclosure should not be so limited, since those familiar with the art to which this invention relates will recognize various alternative designs and embodiments for practicing the invention within the scope of the appended claims.

What is claimed is:

1. A safety system for a vehicle comprising:
at least one sensor mounted such that an object outside the vehicle may be detected by the at least one sensor;
an electronic control unit for the safety system, wherein the electronic control unit is connected to the at least one infrared camera and the at least one camera to determine if an object outside of the vehicle is an animal;
an indicator unit connected to the electronic control unit, wherein the indicator unit is capable of providing an indicator to an operator of the vehicle when the electronic control unit determines that an animal has been detected; and
an external signal device to provide at least one of a audio or visual signal to deter an animal from approaching the vehicle.

2. The safety system of claim 1, wherein the at least one sensor is one of an infrared camera, a camera, a radar sensor and a lidar sensor.

3. The safety system of claim 1, wherein the electronic control unit is connected to at least one vehicle system to initiate at least one of an accident avoidance response and an accident preparation response for the vehicle.

4. The safety system of claim 3, wherein the at least one vehicle system is one of a brake system, a warning device, an active driver assistance system, an airbag deployment unit, and a seat belt tensioner.

5. The safety system of claim 1, wherein the electronic control unit is connected to at least one communication system to send a signal to an external location regarding information about the animal detection.

6. The safety system of claim 5, wherein the external location is another vehicle.

7. The safety system of claim 1, wherein the type of signal from the external signal device is selected based upon one of the type of animal detected and a type of animal preselected in the safety system.

8. A method of avoiding a collision for a vehicle comprising:
detecting an object in an environment surrounding the vehicle with at least one sensor;
determining a location of the vehicle and providing data to an electronic control unit regarding animal population corresponding to the location;
analyzing the information from the at least one sensor and the animal population data to determine if the object is likely an animal;
providing a warning indicator to an operator of the vehicle when the object is determined to be an animal; and
emitting a deterring signal from the vehicle to deter the animal from approaching the vehicle when the object is determined to be an animal.

9. The method of claim 8, wherein the detecting the object with at least one sensor further comprises using one of an infrared camera, a camera, a radar sensor and a lidar sensor.

10. The method of claim 8, further comprising initiating at least one of an accident avoidance response and an accident preparation response for the vehicle.

11. The method of claim 10, wherein the initiating at least one of an accident avoidance response and an accident preparation response further comprises initiating at least one of a brake system, a warning device, an active driver assistance system, an airbag deployment unit, and a seat belt tensioner.

12. The method of claim 8, wherein the type of deterring signal is selected based upon one of the type of animal detected and a type of animal preselected in the safety system.

13. The method of claim 8, further comprising sending information from the vehicle to an external device to communicate that an animal was detected by the vehicle.

14. The method of claim 13, wherein the external device is another vehicle.

15. The method of claim 13, wherein sending the information further comprises sending the vehicle location.

16. A method of detecting an animal comprising:
detecting an object in an environment surrounding a vehicle with at least one sensor including an infrared camera mounted to the vehicle;
determining a location of the vehicle and providing data to an electronic control unit regarding animal population corresponding to the location;
analyzing the information from the at least one sensor and the animal population data to determine if the object is likely an animal;
providing a warning indicator to an operator of the vehicle when the object is determined to be an animal;
emitting a deterring signal from the vehicle to deter the animal from approaching the vehicle when the object is determined to be an animal; and
sending a signal to at least one safety system for the vehicle to modify a setting of the at least one safety system to provide an action that minimizes damage to at least one of the vehicle and a passenger in the event of an impact with the animal.

17. The method of claim 16, further comprising sending information from the vehicle to an external device to communicate that an animal was detected by the vehicle.

18. The method of claim 16, wherein the external device is another vehicle.

19. The method of claim 16, wherein the sending a signal to at least one safety system further comprises initiating at least one of a brake system, a warning device, an active driver assistance system, an airbag deployment unit, and a seat belt tensioner.

20. The method of claim 16, wherein the type of deterring signal is selected based upon one of the type of animal detected and a type of animal preselected in the safety system.
